(19) United States
(12) Patent Application Publication
(10) Pub. No.: US 2006/0168414 A1
(43) Pub. Date: Jul. 27, 2006

(54) Memory block locking apparatus and methods

(75) Inventors: Dean Nobunaga, Cupertino, CA (US); Ebrahim Abedifard, Sunnyvale, CA (US)

Correspondence Address: LEFFERT JAY & POLGLAZE, P.A.;Attn: Tod A. Myrum, P.O. Box 581009, Minneapolis, MN, 55402, US

(73) Assignee: Micron Technology, Inc.

(21) Appl. No.: 11/042,256

(22) Filed: Jan. 25, 2005

(51) Int. Cl. G06F 12/14

(52) U.S. Cl. 711/163

(57) ABSTRACT

Memory block locking apparatus and methods are provided. A method of operating a memory device includes preventing programming of upper and lower bound regions of a memory array of the memory device and any regions of the memory array having addresses between addresses of the upper and lower bound regions or preventing programming of any regions of the memory array having addresses greater than the address of the upper bound region and/or addresses less than the address of the lower bound region.

### TECHNICAL FIELD OF THE INVENTION

The present invention relates generally to memory devices and in particular the present invention relates to memory block locking apparatus and methods.

### BACKGROUND OF THE INVENTION

Memory devices are typically provided as internal storage areas in computers. The term memory identifies data storage that comes in the form of integrated circuit chips. In general, memory devices contain an array of memory cells for storing data, and row and column decoder circuits coupled to the array of memory cells for accessing the array of memory cells in response to an external address.

One type of memory is a non-volatile memory known as flash memory. A flash memory is a type of EEPROM (electrically-erasable programmable read-only memory) that can be erased and reprogrammed in blocks. Many modern personal computers (PCs) have their BIOS stored on a flash memory chip so that it can easily be updated if necessary. Such a BIOS is sometimes called a flash BIOS. Flash memory is also popular in wireless electronic devices because it enables the manufacturer to support new communication protocols as they become standardized and to provide the ability to remotely upgrade the device for enhanced features.

A typical flash memory comprises a memory array that includes a large number of memory cells arranged in row and column fashion. Each of the memory cells includes a floating-gate field-effect transistor capable of holding a charge. The cells are usually grouped into blocks. Each of the cells within a block can be electrically programmed on an individual basis by charging the floating gate. The charge can be removed from the floating gate by a block erase operation. The data in a cell is determined by the presence or absence of the charge on the floating gate.

NOR and NAND flash memory devices are two common types of flash memory devices, so called for the logical form the basic memory cell configuration in which each is arranged. Typically, for NOR flash memory devices, the control gate of each memory cell of a row of the array is connected to a word line, and the drain region of each memory cell of a column of the array is connected to a bit line. The memory array for NOR flash memory devices is accessed by a row decoder activating a row of floating gate memory cells by selecting the word line connected to their control gates. The row of selected memory cells then place their data values on the column bit lines by flowing a differing current, depending upon their programmed states, from a connected source line to the connected column bit lines.

The array of memory cells for NAND flash memory devices is also arranged such that the control gate of each memory cell of a row of the array is connected to a word line. However, each memory cell is not directly connected to a column bit line by its drain region. Instead, the memory cells of the array are arranged together in strings (often termed NAND strings), e.g., of 32 each, with the memory cells connected together in series, source to drain, between a source line and a column bit line. The memory array for NAND flash memory devices is then accessed by a row decoder activating a row of memory cells by selecting the word line connected to a control gate of a memory cell. In addition, the word lines connected to the control gates of unselected memory cells of each string are driven to operate the unselected memory cells of each string as pass transistors, so that they pass current in a manner that is unrestricted by their stored data values. Current then flows from the source line to the column bit line through each series connected string, restricted only by the selected memory cells of each string. This places the current-encoded data values of the row of selected memory cells on the column bit lines.

Memory block locking is a common feature for NOR flash memory devices. When a block is locked, only read access is allowed to that block, and any write access, whether an erase or program operation, is prohibited so that the data within that block remains unchanged. For many conventional block-locking schemes, each memory block has a lock control register assigned to it, and locking or unlocking a block is accomplished by setting or resetting the assigned lock control register. However, for NAND flash memory arrays, the number of memory blocks is often 1000 or 2000 compared to about 16 or 32 for many NOR flash memory arrays, and assigning a lock control register to each memory block may be unfeasible and/or unwieldy.

For the reasons stated above, and for other reasons stated below which will become apparent to those skilled in the art upon reading and understanding the present specification, there is a need in the art for alternative block-lock methods for NAND memory devices.

### SUMMARY

The above-mentioned problems with block-lock methods for NAND memory devices and other problems are addressed by the present invention and will be understood by reading and studying the following specification.

For one embodiment, the invention provides a method of operating a memory device that includes preventing programming of upper and lower bound regions of a memory array of the memory device and any regions of the memory array having addresses between addresses of the upper and lower bound regions or preventing programming of any regions of the memory array having addresses greater than the address of the upper bound region and/or addresses less than the address of the lower bound region.

For another embodiment, the invention provides a method of operating a memory device that includes receiving a write command having a block address of a memory block of a memory array of the memory device, determining whether the block address is greater than or equal to a lower bound address and less than or equal to an upper bound address, preventing the memory block from being written to when the block address is greater than or equal to the lower bound address and less than or equal to the upper bound address when a control bit has a first logic level, and writing to the memory block having the block address when the block address is greater than or equal to the lower bound address and less than or equal to the upper bound address when the control bit has a second logic level.

For another embodiment, the invention provides a memory device with a memory array and logic circuitry adapted to compare an incoming address with an upper bound address corresponding to an upper bound region of the memory array and a lower bound address corresponding to a lower bound region of the memory array and to selectively prohibit write access in response to comparing the incoming address with the upper and lower bound addresses.

Further embodiments of the invention include methods and apparatus of varying scope.

### BRIEF DESCRIPTION OF THE DRAWINGS

FIG. 1 is a block diagram illustration of a memory system, according to an embodiment of the invention.

FIG. 2 provides an example of locked and unlocked memory blocks of a memory array, according to another embodiment of the invention.

FIG. 3 provides an example of locked and unlocked memory blocks of a memory array, according to another embodiment of the invention.

FIG. 4 is a logic diagram of exemplary logic circuitry of a memory device, according to another embodiment of the invention.

FIG. 5 is a logic diagram of exemplary logic circuitry of a of an address-check logic block, according to another embodiment of the invention.

FIG. 6 is a logic diagram of exemplary logic circuitry of a bit-check block, according to another embodiment of the invention.

FIG. 7 is a logic diagram of exemplary logic circuitry of a bit-check block, according to another embodiment of the invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

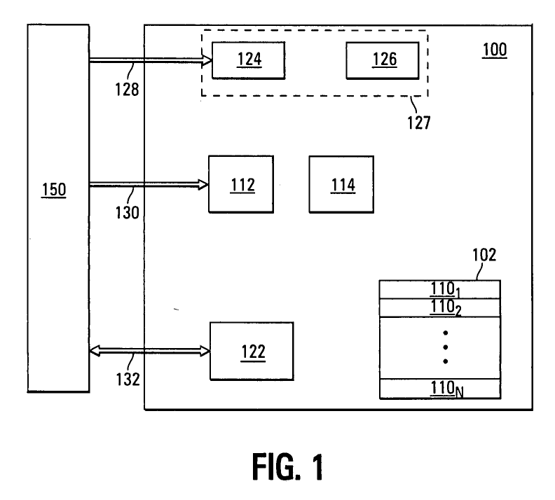

FIG. 1 is a block diagram illustration of a memory system, according to an embodiment of the invention. The memory system includes a memory device 100, such as a NAND flash memory device. Memory device 100 includes a memory array 102 having a plurality of memory cells arranged in row and column fashion. For one embodiment, each of the memory cells includes a floating-gate field-effect transistor capable of holding a charge for the non-volatile storage of data. Each of the cells can be electrically programmed on an individual basis by charging the floating gate. Memory array 102 is arranged in blocks 110 of rows and columns of memory cells. For one embodiment, each memory block 110 spans a NAND string, e.g., 32 memory cells connected source to drain in series and select gates at either end of the NAND string in the column or (Y-) direction and spans a plurality of columns in the row (or X-) direction, e.g. about 2000.

Memory array 102 can be accessed using externally provided location addresses received by an address register 112 via address signal connections 130. The address signals are decoded, and one or more target memory cells are selected in response to the decoded address signals, using the access circuitry 114 that includes decode and select circuitry.

Data is input and output through an I/O circuit 122 via data connections 132. I/O circuit 122 includes data output registers, output drivers, and output buffers. For one embodiment, the address signals are also received via data connections 132. Command execution logic 124 is provided to control the basic operations of the memory device 100 in response to control signals received via control signal connections 128. A state machine 126 may also be provided to control specific operations performed on the memory array and the memory cells. The command execution logic 124 and/or state machine 126 can be generally referred to as control circuitry 127 to control read, write, erase, and other memory operations. The control circuitry 127 is adapted to facilitate the methods of the various embodiments. The data connections 132 are typically used for bi-directional data communication. The memory can be coupled to an external processor 150 for operation as part of an electronic system. An example of a processor 150 includes a memory controller in a personal computer.

It will be appreciated by those skilled in the art that additional circuitry and control signals can be provided, and that the memory device of FIG. 1 has been simplified to help focus on the invention. It will further be understood that the above description of a memory device is intended to provide a general understanding of the memory and is not a complete description of all the elements and features of a typical memory device.

For one embodiment, memory device 100 is programmed so that a group of blocks 110 of memory array 102 is locked (or write protected or read only). That is, only read access is allowed to that group of blocks 110, and any write access (erase or programming), whether an erase or data program operation, is prohibited. This is accomplished by designating upper and lower boundaries of the group of blocks, by specifying their addresses, and indicating whether the group of blocks is locked or unlocked. For one embodiment, a lock-block command causes a lower-bound address to be written to a lower-bound lock-block register, an upper-bound address to be written to an upper-bound lock-block register, and a control bit having a first logic level, e.g., a logic high, to be written to a block-lock control register so that blocks 110 having block addresses greater than or equal to the lower bound address and less than or equal to the upper bound address are locked or a control bit having a second logic level, e.g., a logic low, to be written to the block-lock control register so that blocks 110 having block addresses greater than or equal to the lower bound address and less than or equal to the upper bound address are unlocked.

For one embodiment, when the upper and lower boundaries have the same block address and the control bit is at the first logic level, all the blocks are unlocked except the one block having that block address. For another embodiment, when the upper and lower boundaries have the same block address and the control bit is at the second logic level, all the blocks are locked except the one block having that block address. For other embodiments, if the lower boundary address is greater than the upper address, an error is indicated, e.g., an error flag is set, and all of the blocks are locked, irrespective of the logic level of the control bit.

For another embodiment, memory device 100 is configured so that all of the blocks 10 are selected upon power up of memory device 100. That is, a default lower boundary corresponds to the address of the first memory block 100₁ of memory array 102, and a default upper boundary corresponds to the address of the last memory block 100_{N} of memory array 102. The control bit may be at the first logic level so that default group of blocks 110 is locked upon power up of memory device 100 or may be at the second logic level so that default group of blocks 110 is unlocked upon power up.

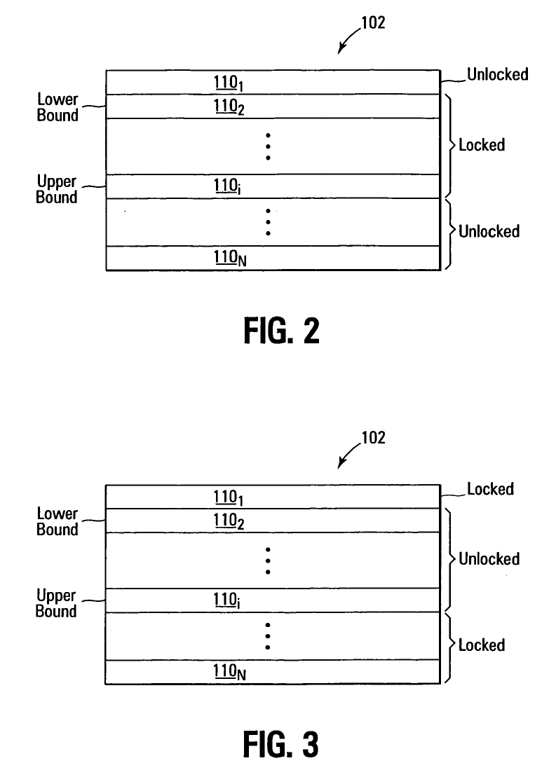

FIG. 2 provides an example, according to one embodiment, of when the lower bound address is the address for block 110₂, the upper bound address is the address for block 110ᵢ, and the control bit is at the first logic level so that blocks 110₂ and 110ᵢand any blocks therebetween are locked and the remaining blocks are unlocked. FIG. 3 provides an example, according to another embodiment, of when the lower bound address is the address for block 110₂, the upper bound address is the address for block 110ᵢ, and the control bit is at the second logic level so that blocks 110₂ and 110ᵢ and any blocks therebetween are unlocked and the remaining blocks are locked.

During operation, for one embodiment, when a write (erase or programming) command is issued, the block address associated with the write command is checked against the upper and lower bound addresses and the logic level of the control bit is checked to determine whether the block having the block address associated with the write command is locked (write protected) or not. If it the addressed block is locked then the write operation is aborted and an error is indicated, e.g., by setting an error flag. Otherwise, the write operation proceeds.

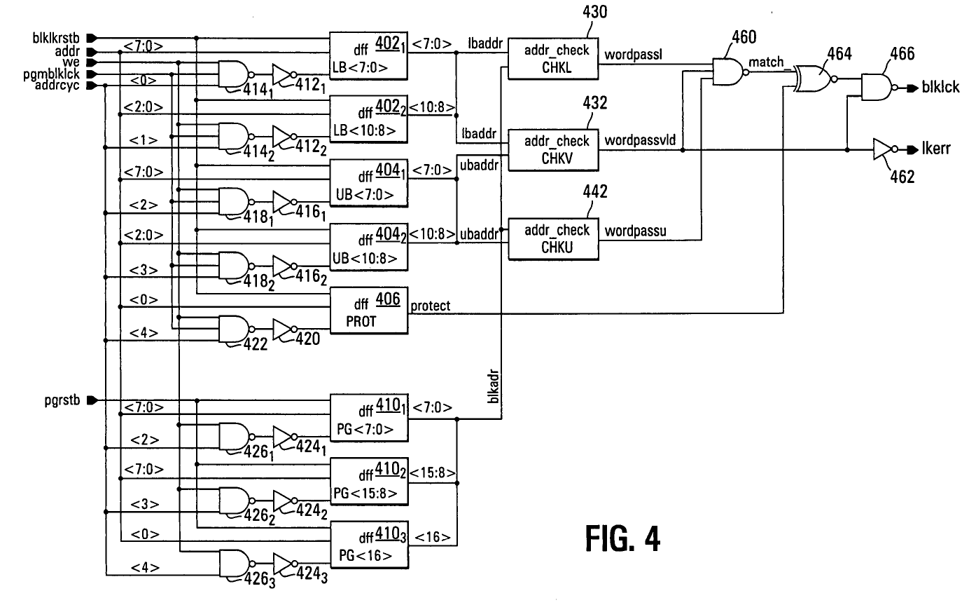

FIG. 4 is a logic diagram of exemplary logic circuitry 400 of a memory device, e.g., as a portion of command execution logic 124 of memory device 100, according to another embodiment of the invention. For one embodiment, logic circuitry 400 includes lower-bound lock-block registers 402, upper-bound lock-block registers 404, and a block-lock control register 406. Also included are address registers 410 that receive addresses that come in with an incoming write command.

A first input of each of lower-bound lock-block registers 402 is coupled to an output of an inverter 412. Each inverter 412 has an input coupled to a corresponding NAND gate 414. A first input of each of upper-bound lock-block registers 404 is coupled to an output of an inverter 416. Each inverter 416 has an input coupled to a corresponding NAND gate 418. A first input of block-lock control register 406 is coupled to an output of an inverter 420 having an input coupled to a NAND gate 422. A first input of each of address registers 410 is coupled to an output of an inverter 424. Each inverter 424 has an input coupled to a corresponding NAND gate 426.

A first input of a lower-bound address-check logic block 430 is coupled to receive a lower bound address from lower-bound lock-block registers 402, as is a first input of an upper/lower bound address-validation-check logic block 432. A second input of lower-bound address-check logic block 430 is coupled to receive an address from address registers 410. A second input of upper/lower bound address-validation-check logic block 432 is coupled to receive an upper bound address from upper-bound lock-block registers 404. A first input of an upper-bound address-check logic block 442 is coupled to receive an address from address registers 410. A second input of upper-bound address-check logic block 442 is coupled to receive an upper bound address from upper-bound lock-block registers 404.

Outputs of lower-bound address-check logic block 430, upper/lower bound address-validation-check logic block 432, and upper-bound address-check logic block 442 are respectively coupled to inputs of a NAND gate 460. The output of upper/lower bound address-validation-check logic block 432 is also coupled to an input of an inverter 462 and a first input of a NAND gate 466. An output of NAND gate 460 is coupled to a first input of an XNOR gate 464. A second input of XNOR gate 464 is coupled to an output of block-lock control register 406. An output of XNOR gate 464 is coupled to a second input of NAND gate 466.

During operation, for one embodiment, first, second, and third inputs of each of NAND gates 414, 418, and 422 respectively receive a write-enable clock command we, a program block lock command pgmblklck, and an address cycle command addrcyc, e.g., having five cycles. For another embodiment, for example, when write-enable clock command we, a program block lock command pgmblklck, and an address cycle command addrcyc each have a first logic level, such as a logic high (or logic 1), the first eight bits of the lower bound address are loaded in lower-bound lock-block register 402₁ during a first cycle of address cycle command addrcyc, the next three bits of the lower bound address are loaded in lower-bound lock-block register 402₂ during a second cycle of address cycle command addrcyc, the first eight bits of the upper bound address are loaded in upper-bound lock-block register 404₁ during a third cycle of address cycle command addrcyc, the next three bits of the upper bound address are loaded in upper-bound lock-block register 404₂ during a fourth cycle of address cycle command addrcyc, and a control bit, having either the first or a second (e.g., a logic low) logic level, is stored in block-lock control register 406 during a fifth cycle of address cycle command addrcyc. A block lock reset command blklkrstb command resets lower-bound lock-block registers 402, upper-bound lock-block registers 404, and block-lock control register 406, e.g., to zeros, during power up or in response to a device reset, for example.

For some embodiments, the first eight bits of the lower bound address that were loaded during the first cycle of address cycle command addrcyc may be stored in corresponding non-volatile memory cells of the memory device, e.g., of memory array 102 of memory device 100 of FIG. 1, and the next three bits of the lower bound address that were loaded during the second cycle of address cycle command addrcyc may be stored in corresponding non-volatile memory cells of memory array 102. Moreover, the first eight bits of the upper bound address that were loaded during the third cycle of address cycle command addrcyc may be stored in corresponding non-volatile memory cells of memory array 102, and the next three bits of the upper bound address that were loaded during the fourth cycle of address cycle command addrcyc may be stored in corresponding non-volatile memory cells of memory array 102. Further, the control bit that was loaded during the fifth cycle of address cycle command addrcyc may be stored in a corresponding non-volatile memory cell of memory array 102. For these embodiments, the upper and lower bound addresses and the control bit may be stored in the memory array before the memory device is powered down, so they can be respectively returned to lower-bound lock-block registers 402, upper-bound lock-block registers 404, and block-lock control register 406 after the memory device is re-powered up.

During a write (erase or program) cycle, for one embodiment, when write-enable clock command we and an address cycle command addrcyc each have a first logic level, column addresses are loaded in address registers 410 during the first and second cycle of address cycle command addrcyc and row and block addresses are loaded in address registers 410 during the next three cycles of address cycle command addrcyc. For another embodiment, a reset commandpgrstb resets address registers 410, e.g., to all zeros, during power up, for example.

Lower-bound address-check logic block 430 compares block addresses from address registers 410 to the lower bound address from lower-bound lock-block registers 402. When the block address is greater than or equal to the lower bound address, for one embodiment, lower-bound address-check logic block 430 outputs a lower bound word-pass signal wordpassl having logic high to the respective input of NAND gate 460. Otherwise, lower-bound address-check logic block 430 outputs a lower bound word-pass signal wordpassl having logic low to the respective input of NAND gate 460.

Upper-bound address-check logic block 442 compares block addresses from address registers 410 to the upper bound address from upper-bound lock-block registers 404. When the block address is less than or equal to the upper bound address, for one embodiment, upper-bound address-check logic block 442 outputs an upper bound word-pass signal wordpassu having logic high to the respective input of NAND gate 460. Otherwise, upper bound address-check logic block 442 outputs a upper bound word-pass signal wordpassu having logic low to the respective input of NAND gate 460.

Upper/lower bound address-validation-check logic block 432 compares the upper and lower bound addresses. When the lower bound address is less than or equal to the upper bound address, upper/lower bound address-validation-check logic block 432 outputs a word-pass valid signal wordpassvld having logic high, for one embodiment, to the respective input of NAND gate 460, the input to inverter 462, and the first input of NAND gate 466. Otherwise, upper/lower bound address-validation-check logic block 432 outputs a word-pass valid signal wordpassvld having logic low to the respective input of NAND gate 460, the input to inverter 462, and the first input of NAND gate 466.

When a block address is greater than or equal to the lower bound address and less than or equal to the upper bound address and when the lower bound address is less than or equal to the upper bound address, the lower bound word-pass signal wordpassl, upper bound word-pass signal wordpassu, and word-pass valid signal wordpassvld are respectively logic highs, for one embodiment. Therefore, each of the inputs of NAND gate 460 is logic high, and NAND gate 460 outputs a match signal match_ having logic low to the first input of XNOR gate 464. Moreover, the first input of NAND gate 466 is logic high, as is the input to inverter 462. Therefore, inverter 462 outputs a lock error signal lkerr having a logic low, indicative of no error, when the lower bound address is less than or equal to the upper bound address.

When the control bit of block-lock control register 406 is logic high, for one embodiment, the second input of XNOR gate 464 is a logic high, and, since the match signal match_ is logic low at the first input of XNOR gate 464, XNOR gate 464 outputs a logic low to the second input of NAND gate 466. Therefore, the first and second inputs of NAND gate 466 are respectively logic high and logic low, and a block lock signal blklck at an output of NAND gate 466 is logic high. For this embodiment, when the block lock signal blklck is high, the block address is locked, and the block having that block address cannot be accessed for programming. This means that when the lower bound address is less than or equal to the upper bound address and when the control bit of block-lock control register 406 is logic high, the blocks corresponding to the upper and lower bound addresses and all of the blocks therebetween are locked, as shown in FIG. 2, and cannot be accessed during a write (or program) operation so that they cannot be programmed. For another embodiment, any remaining blocks, i.e., any blocks having block addresses that are greater than the upper bound address and any blocks having block addresses that are less than the lower bound address, are unlocked, as shown in FIG. 2, and can be programmed.

When the control bit of block-lock control register 406 is logic low, for one embodiment, the second input of XNOR gate 464 is logic low, and, with the match signal match_ logic low at the first input of XNOR gate 464, i.e., the block address is greater than or equal to the lower bound address and less than or equal to the upper bound address, XNOR gate 464 outputs a logic high to the second input of NAND gate 466. With the first input of NAND gate 466 logic high, i.e., the lower bound address less than the upper bound address, the block lock signal blklck at the output of NAND gate 466 is logic low. For this embodiment, when the block lock signal blklck is logic low, the block address is unlocked, and the block having that block address can be accessed for programming. This means that when the lower bound address is less than or equal to the upper bound address and when the control bit of block-lock control register 406 is logic low, the blocks corresponding to the upper and lower bound addresses and all of the blocks therebetween are unlocked, as shown in FIG. 3, and can be accessed during a write or program operation so that they can be programmed. For another embodiment, any remaining blocks, i.e., any blocks having block addresses that are greater than the upper bound address and any blocks having block addresses that are less than the lower bound address, are locked, as shown in FIG. 3, and cannot be programmed.

For one embodiment, if the lower bound address is greater than the upper bound address, the word-pass valid signal wordpassvld is logic low at the respective input of NAND gate 460, the input to inverter 462, and the first input of NAND gate 466. Therefore, the lock error signal lkerr after inverter 462 is logic high, indicating an error. Moreover, since at least one of the inputs to NAND gate 460 is logic low, match signal match_ is logic high at the first input of XNOR gate 464.

When the control bit of block-lock control register 406 is logic high, both inputs of XNOR gate 464 are logic high, and the second input of NAND gate 466 is logic high. Therefore, with the first input of NAND gate 466 logic low, block lock signal blklck is high, meaning that the memory array cannot be accessed for programming. When the control bit of block-lock control register 406 is logic low, the second input of XNOR gate 464 is logic low, while the first input is logic high, and the second input of NAND gate 466 is logic low. Therefore, with the first input of NAND gate 466 logic low, block lock signal blklck is high, meaning that the memory array cannot be accessed for programming. Consequently, whenever the lower bound address is greater than the upper bound address, the memory array cannot be accessed for programming, regardless of whether the control bit of block-lock control register 406 is high or low.

As indicated above, lower-bound address-check logic block 430 outputs a lower bound word-pass signal wordpassl having logic low to the respective input of NAND gate 460 whenever a block address of an incoming write command is less than the lower bound address. Also indicated above is that upper-bound address-check logic block 442 outputs an upper bound word-pass signal wordpassu having logic low to the respective input of NAND gate 460 whenever a block address of an incoming write command is greater than the upper bound address. Note that whenever the upper bound address is greater than the lower bound address, one of the inputs of NAND gate 460 is logic high, as explained above. Consequently, at least one input of NAND gate 460 is logic low whenever a block address is less than the lower bound address or is greater than the upper bound address, so the match signal match_ is logic high at the first input of XNOR gate 464. When the control bit of block-lock control register 406 is logic high, the second input of XNOR gate 464 is logic high so that the second input of NAND gate 466 is logic high. When the control bit of block-lock control register 406 is logic low, the second input of XNOR gate 464 is logic low so that the second input of NAND gate 466 is a logic low.

Whenever the upper bound address is greater than the lower bound address, the first input of NAND gate 466 is logic high, as explained above. Therefore, when the control bit of block-lock control register 406 is logic high, the block lock signal blklck at an output of NAND gate 466 is logic low, and the blocks having addresses greater than the upper bound address or less than the lower bound address are not locked, as shown in FIG. 2, and can be programmed. On the other hand, when the control bit of block-lock control register 406 is logic low, the block lock signal blklck at an output of NAND gate 466 is logic high, and the blocks having addresses greater than the upper bound address or less than the lower bound address are locked, as shown in FIG. 3, and cannot be programmed.

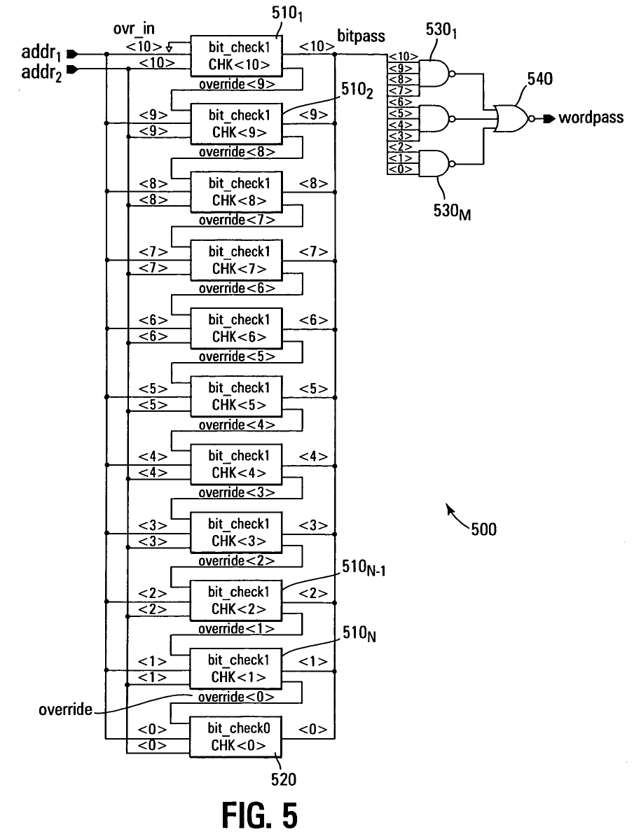

FIG. 5 is a logic diagram of exemplary logic circuitry 500 of an address-check logic block, such as lower-bound address-check logic block 430, upper/lower bound address-validation-check logic block 432, or upper-bound address-check logic block 442, according to another embodiment of the invention. Logic circuitry 500 receives a first address addr₁ and a second address addr₂ that may respectively correspond to the upper and lower bound addresses, a block address and the lower bound address, or the upper bound address and the block address. For one embodiment, logic circuitry 500 includes bit-check blocks 510 and a bit-check block 520. A first output of each of bit-check blocks 510 and bit-check block 520 is coupled one to one to an input of a NAND gate 530 of a bank of NAND gates 530. An output of each NAND gate 530 is coupled one to one to an input of a NOR gate 540.

First and second inputs of each of bit-check blocks 510 and bit-check block 520 respectively receive a bit of the first address addr₁ and a corresponding bit of the second address addr₂. Each of bit-check blocks 510 and bit-check block 520 compares the bit of the first address addr₁ received thereat to the corresponding bit of the second address addr₂ received thereat. A third input of bit-check block 510₁ is coupled to ground and thus receives a logic low input that corresponds to an override input signal ovr_in. A second output of each of bit-check blocks 510₁ to 510_{N-1} is coupled to a third input of a succeeding bit-check block 510, and a second output of bit-check block 510_{N} is coupled to a third input of bit-check block 520. The second output of a bit-check block 510 outputs an override signal override to the third input of the succeeding bit-check block 510 or 520.

Whenever the first address addr₁ is greater than or equal to the second address addr₂, each of bit-check blocks 510 and 520 outputs a bit-pass signal bitpass having logic high to the respective input of the bank of NAND gates 530. Therefore, each of the inputs of NOR gate 540 is logic low, and NOR gate 540 outputs a word-pass signal wordpass having logic high. Whenever, the first address addr₁ is less than the second address addr₂, one or more of bit-check blocks 510 and 520 outputs a bit-pass signal bitpass having logic low to the respective input to the bank of NAND gates 530. Therefore, one or more of the inputs of NOR gate 540 is logic high, and NOR gate 540 outputs a word-pass signal wordpass having logic low. For one embodiment, the second output of a bit-check block 510 outputs the override signal override to the third input of the succeeding bit-check block 510 or 520 to ensure that each of bit-check blocks 510 and 520 outputs a bit-pass signal bitpass having logic high to the respective input to the bank of NAND gates 530 whenever the first address addr₁ is greater than the second address addr₂, irrespective of whether a bit of the first address addr₁ is less than the corresponding bit of the second address addr₂ at one or more of bit-check blocks 510₂ to 510_{N} and 520.

Note that bit-check block 510₁ compares the first bit, e.g., the most significant bit, of the first address addr₁ to the first bit, e.g., the most significant bit, of the second address addr2, the next bit-check block 510₂ compares the next bit of the first address addr₁ to the next bit of the second address addr2, and so on until bit-check block 510_{N} compares the Nth bit of the address addr₁ to the Nth bit of the second address addr2 and bit-check block 520 compares the N+1 bit of the address addr₁ to the N+1 bit of the second address addr2.

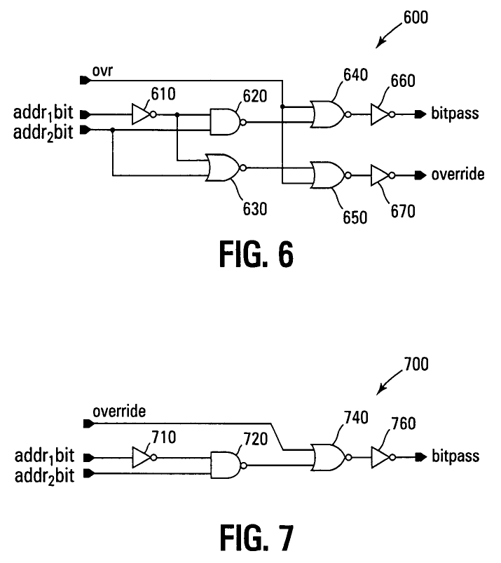

FIG. 6 is a logic diagram of exemplary logic circuitry 600 of a bit-check block, such as a bit-check block 510, according to another embodiment of the invention. Logic circuitry 600 includes an inverter 610 coupled to a first input of a NAND gate 620 and a first input of a NOR gate 630. An output of NAND gate 620 is coupled to a first input of a NOR gate 640, and an output of NOR gate 630 is coupled to a first input of a NOR gate 650. Outputs of NOR gates 640 and 650 are respectively coupled to inverters 660 and 670.

Inverter 610 receives an address bit of the first address addr₁bit. The first inputs of NAND gate 620 and NOR gate 630 each receive an inverted address bit of the first address addr₁bit from inverter 610, while second inputs of NAND gate 620 and NOR gate 630 each receive a corresponding address bit of the second address addr₂bit. Second inputs of NOR gates 640 and 650 each receive an override signal ovr, e.g., corresponding to either override input signal ovr_in, such as when logic circuitry 600 corresponds to bit-check block 510₁, of FIG. 5 or the override signal override, such as when logic circuitry 600 corresponds to one of bit-check blocks 510₂ to 510_{N}, of FIG. 5. Note that override signal ovr is logic low when logic circuitry 600 corresponds to bit-check block 510₁.

When logic circuitry 600 corresponds to bit-check block 510₁ and the address bit of the first address addr₁bit is logic high and the corresponding address bit of the second address addr₂bit is logic low, i.e., the address bit of the first address addr₁bit is greater than the corresponding address bit of the second address addr₂bit, the first inputs of NAND gate 620 and NOR gate 630 after inverter 610 are logic lows, and the second inputs of NAND gate 620 and NOR gate 630 are logic lows. Therefore, the first inputs of NOR gates 640 and 650 are logic highs, and the second inputs of NOR gates 640 and 650 are logic lows, since override signal ovr is logic low. Consequently, the outputs of NOR gates 640 and 650 are logic lows, and the bit-pass signal bitpass is logic high after inverter 660 and the override signal override after inverter 670 is logic high.

When logic circuitry 600 corresponds to bit-check block 510₁ and the corresponding address bits of the first and second addresses addr₁bit and addr₂bit are equal, the first and second inputs of NAND gate 620 are different, as are the first and second inputs of NOR gate 630. Therefore, the first input of NOR gate 640 is logic high; the first input of NOR gate 650 is logic low; and the second inputs of NOR gates 640 and 650 are logic lows, since override signal ovr is logic low. Consequently, the outputs of NOR gate 640 and 650 are respectively logic low and logic high, and the bit-pass signal bitpass is logic high after inverter 660 and the override signal override after inverter 670 is logic low.

When logic circuitry 600 corresponds to bit-check block 510₁ and the address bit of the first address addr₁bit is logic low and the corresponding address bit of the second address addr₂bit is logic high, i.e., the address bit of the first address addr₁bit is less than the corresponding address bit of the second address addr₂bit, the first inputs of NAND gate 620 and NOR gate 630 after inverter 610 are logic highs, and the second inputs of NAND gate 620 and NOR gate 630 are logic highs. Therefore, the first inputs of NOR gates 640 and 650 are logic lows, and the second inputs of NOR gates 640 and 650 are logic lows, since override signal ovr is logic low. Consequently, the outputs of NOR gates 640 and 650 are logic highs, and the bit-pass signal bitpass is logic low after inverter 660 and the override signal override after inverter 670 is logic low.

When logic circuitry 600 corresponds to one of the bit-check blocks 510₂ to 510_{N} and the address bit of the first address addr₁bit is logic high and the corresponding address bit of the second address addr₂bit is logic low, i.e., the address bit of the first address addr₁bit is greater than the corresponding address bit of the second address addr₂bit, the first inputs of NAND gate 620 and NOR gate 630 after inverter 610 are logic lows, and the second inputs of NAND gate 620 and NOR gate 630 are logic lows. Therefore, the first inputs of NOR gates 640 and 650 are logic highs, and the second inputs of NOR gates 640 and 650 are logic lows when the override signal ovr is logic low and logic highs when the override signal ovr is logic high. Note that when logic circuitry 600 corresponds to one of the bit-check blocks 510₂ to 510_{N}, the override signal ovr corresponds to the override signal override output from the preceding bit-check block 510, and can be either logic high or low.

Consequently, when the first inputs of NOR gates 640 and 650 are logic highs and the second inputs of NOR gates 640 and 650 are logic lows, i.e., the override signal ovr is logic low, outputs of NOR gates 640 and 650 are logic lows, and the bit-pass signal bitpass is logic high after inverter 660 and the override signal override after inverter 670 is logic high. When the first inputs of NOR gates 640 and 650 are logic highs and the second inputs of NOR gates 640 and 650 are logic highs, i.e., the override signal ovr is logic high, outputs of NOR gates 640 and 650 are logic lows, and the bit-pass signal bitpass is logic high after inverter 660 and the override signal override after inverter 670 is logic high. Therefore, logic circuitry 600 outputs a bit-pass signal bitpass and an override signal override that are logic highs whenever the address bit of the first address addr₁bit is greater than the corresponding address bit of the second address addr₂bit, irrespective of the logic level of the override signal ovr.

When logic circuitry 600 corresponds to one of the bit-check blocks 510₂ to 510_{N} and the corresponding address bits of the first and second addresses addr₁bit and addr₂bit are equal, the first and second inputs of NAND gate 620 are different, as are first and second inputs of NOR gate 630. Therefore, the first input of NOR gate 640 is logic high; the first input of NOR gate 650 is logic low; and the second inputs of NOR gates 640 and 650 are logic lows when the override signal ovr is logic low and logic highs when the override signal ovr is logic high.

Consequently, when the first input of NOR gate 640 is logic high, the first input of NOR gate 650 is logic low, and the second inputs of NOR gates 640 and 650 are logic lows, i.e., the override signal ovr is logic low, the outputs of NOR gates 640 and 650 are respectively logic low and logic high, and the bit-pass signal bitpass is logic high after inverter 660 and the override signal override after inverter 670 is logic low. When the first input of NOR gate 640 is logic high, the first input of NOR gate 650 is logic low, and the second inputs of NOR gates 640 and 650 are logic highs, i.e., the override signal ovr is logic high, the outputs of NOR gates 640 and 650 are logic lows, and the bit-pass signal bitpass is logic high after inverter 660 and the override signal override after inverter 670 is logic high. Therefore, when the the corresponding address bits of the first and second addresses addr₁bit and addr₂bit are equal, logic circuitry 600 outputs a bit-pass signal bitpass that is logic high, irrespective of the logic level of the override signal ovr. However, logic circuitry 600 outputs an override signal override that is respectively logic low and logic high when the override signal ovr is logic low and high when the corresponding address bits of the first and second addresses addr₁bit and addr₂bit are equal.

When logic circuitry 600 corresponds to one of the bit-check blocks 510₂ to 510_{N} and the address bit of the first address addr₁bit is logic low and the corresponding address bit of the second address addr₂bit is logic high, i.e., the address bit of the first address addr₁bit is less than the corresponding address bit of the second address addr₂bit, the first inputs of NAND gate 620 and NOR gate 630 after inverter 610 are logic highs, and the second inputs of NAND gate 620 and NOR gate 630 are logic highs. Therefore, the first inputs of NOR gates 640 and 650 are logic lows, and the second inputs of NOR gates 640 and 650 are logic lows when the override signal ovr is logic low and logic highs when the override signal ovr is logic high.

Consequently, when the first inputs of NOR gates 640 and 650 are logic lows and the second inputs of NOR gates 640 and 650 are logic lows, i.e., the override signal ovr is logic low, the outputs of NOR gates 640 and 650 are logic highs, and the bit-pass signal bitpass is logic low after inverter 660 and the override signal override after inverter 670 is logic low. When the first inputs of NOR gates 640 and 650 are logic lows and the second inputs of NOR gates 640 and 650 are logic highs, i.e., the override signal ovr is logic high, the outputs of NOR gates 640 and 650 are logic lows, and the bit-pass signal bitpass is logic high after inverter 660 and the override signal override after inverter 670 is logic high. Therefore, when the address bit of the first address addr₁bit is less than the corresponding address bit of the second address addr₂bit, logic circuitry 600 outputs a bit-pass signal bitpass and an override signal override that are logic lows when the override signal ovr is logic low. However, when the address bit of the first address addr₁bit is less than the corresponding address bit of the second address addr₂bit, logic circuitry 600 outputs a bit-pass signal bitpass and an override signal override that are logic highs when the override signal ovr is logic high. This is because one or more of the preceding address bits of the first address is greater than its corresponding address bit of the second address.

Note that the override signal ovr is logic high when the override signal ovr corresponds to the override signal override from a preceding bit-check block 510. If the preceding bit-check block 510 is bit-check block 510₁ , which compares the first address bit of the first address addr₁ to the first address bit of the second address addr2, as indicated above, then the override signal override, and thus the override signal ovr, is logic high only when the first bit of the first address addr₁ is greater than the first bit of the second address addr2. Therefore, the override signal override signal causes the bit-check block 510 that comes immediately after bit-check block 510₁ , e.g., bit-check block 510₂ of FIG. 5, for comparing the second address bit of the first address addr₁ to the second address bit of the second address addr2, to output a bit-pass signal bitpass having logic high when the first bit of the first address addr₁ is greater than the first bit of the second address addr2. This is an example of the override signal override acting to ensure that each of bit-check blocks 510 outputs a bit-pass signal bitpass having logic high whenever the first address addr₁ is greater than or equal to the second address addr₂, irrespective of whether a bit of the first address addr₁ is less than the corresponding bit of the second address addr₂ at one or more of bit-check blocks 510₂ to 510_{N} , as discussed above.

FIG. 7 is a logic diagram of exemplary logic circuitry 700 of a bit-check block, such as bit-check block 520, according to another embodiment of the invention. Logic circuitry 700 includes an inverter 710 coupled to a first input of a NAND gate 720. An output of NAND gate 720 is coupled to a first input of a NOR gate 740. An output of NOR gate 740 is coupled to an inverter 760.

Inverter 710 receives the address bit of the first address addr₁bit, e.g., corresponding to the N+1 bit of the first address addr₁ of FIG. 5, and the first input of NAND gate 720 receives the inverted address bit of the first address addr₁bit from inverter 710. A second input of NAND gate 720 receives the address bit of the second address addr₂bit, e.g., corresponding to the N+1 bit of the second address addr₂ of FIG. 5. A second input of NOR gate 740 receives the override signal override from the preceding one of bit-check blocks 510 of FIG. 5, e.g., bit-check block 510_{N}, that can either be logic high or logic low.

When the address bit of the first address addr₁bit is logic high and the address bit of the second address addr₂bit is logic low, i.e., the address bit of the first address addr₁bit is greater than the address bit of the second address addr₂bit, the first input of NAND gate 720 after inverter 710 is logic low, and the second input of NAND gate 720 is logic low. Therefore, the first input of NOR gate 740 is logic high, and the override signal override at the second input of NOR gate 740 is either logic high or low. When the override signal override at the second input of NOR gate 740 is logic high, the output of NOR gate 740 is logic low, and the bit-pass signal bitpass is logic high after inverter 760. When the override signal override at the second input of NOR gate 740 is logic low, the output of NOR gate 740 is logic low, and the bit-pass signal bitpass is logic high after inverter 760.

When the address bits of the first and second addresses addr₁bit and addr₂bit are equal, the first and second inputs of NAND gate 720 are different. Therefore, the first input of NOR gate 740 is logic high, and the override signal override at the second input of NOR gate 740 is either logic high or low. When the override signal override at the second input of NOR gate 740 is logic high, the output of NOR gate 740 is logic low, and the bit-pass signal bitpass is logic high after inverter 760. When the override signal override at the second input of NOR gate 740 is logic low, the output of NOR gate 740 is logic low, and the bit-pass signal bitpass is logic high after inverter 760. Therefore, the bit-pass signal bitpass is logic high whenever the address bit of the first address addr₁bit is greater than or equal to the address bit of the second address addr₂bit.

When the address bit of the first address addr₁bit is logic low and the address bit of the second address addr₂bit is logic high, i.e., the address bit of the first address addr₁bit is less than the address bit of the second address addr₂bit, the first and second inputs of NAND gate 720 are logic highs. Therefore, the first input of NOR gate 740 is logic low, and the override signal override at the second input of NOR gate 740 is either logic high or low. When the override signal override at the second input of NOR gate 740 is logic high, the output of NOR gate 740 is logic low, and the bit-pass signal bitpass is logic high after inverter 760. When the override signal override at the second input of NOR gate 740 is logic low, the output of NOR gate 740 is logic high, and the bit-pass signal bitpass is logic low after inverter 760.

Therefore, when the override signal override is a logic high and the address bit of the first address addr₁bit is less than the address bit of the second address addr₂bit, the bit-pass signal bitpass is logic high, even though the address bit of the first address addr₁bit is less than the address bit of the second address addr₂bit. This is because one or more of the preceding address bits of the first address is greater than its corresponding address bit of the second address and is an example of the override signal override acting to ensure that bit-check blocks 520 outputs a bit-pass signal bitpass having logic high whenever the first address addr₁ is greater than or equal to the second address addr₂, irrespective of whether a bit of the first address addr₁ is less than the corresponding bit of the second address addr₂ at bit-check block 520, as discussed above.

### CONCLUSION

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A method of operating a memory device, comprising:
preventing programming of upper and lower bound regions of a memory array of the memory device and any regions of the memory array having addresses between addresses of the upper and lower bound regions or preventing programming of any regions of the memory array having addresses greater than the address of the upper bound region and/or addresses less than the address of the lower bound region.

2. The method of claim 1, wherein programming of the upper and lower bound regions and any regions of the memory array having addresses between addresses of the upper and lower bound regions is prevented when a control bit has a first logic level and programming of any regions of the memory array having addresses greater than the address of the upper bound region and/or addresses less than the address of the lower bound region is prevented when the control bit has a second logic level.

3. The method of claim 1 further comprises storing the addresses of the upper and lower bound regions in the memory device.

4. The method of claim 1 further comprises determining whether the address of the upper bound region is greater than or equal to the address of the lower bound region.

5. The method of claim 1 further comprises preventing programming of the memory array whenever the address of the lower bound region is greater than the address of the upper bound region.

6. The method of claim 1, wherein the upper and lower bound regions are upper and lower bound memory blocks of the memory array, the regions of the memory array having addresses between the addresses of the upper and lower bound regions are memory blocks of the memory array having addresses between addresses of the upper and lower bound memory blocks, and the regions of the memory array having addresses greater than the address of the upper bound region and/or addresses less than the address of the lower bound region are memory blocks of the memory array having addresses greater than the address of the upper bound memory block and/or memory blocks of the memory array having addresses less than the address of the lower bound memory block.

7. The method of claim 1 further comprises allowing programming of any regions of the memory array having addresses greater than the address of the upper bound region and/or addresses less than the address of the lower bound region while preventing programming of the upper and lower bound regions and any regions of the memory array having addresses between addresses of the upper and lower bound regions.

8. The method of claim 1 further comprises allowing programming of the upper and lower bound regions and any regions of the memory array having addresses between addresses of the upper and lower bound regions while preventing programming of any regions of the memory array having addresses greater than the address of the upper bound region and/or addresses less than the address of the lower bound region.

9. A method of operating a memory device, comprising:
storing an upper bound address in the memory device corresponding to an upper bound region of a memory array of the memory device;
storing a lower bound address in the memory device corresponding to a lower bound region of the memory array; and
preventing programming of any regions of the memory array having addresses between the upper and lower bound addresses when a control bit of the memory device is at a first logic level.

10. The method of claim 9 further comprises preventing programming of the upper and lower bound regions when the control bit is at the first logic level.

11. The method of claim 10, wherein the lower bound address is equal to the upper bound address.

12. The method of claim 9 further comprises preventing programming of any regions of the memory array having addresses greater than the upper bound address and/or addresses less than the lower bound address when the control bit is at a second logic level.

13. The method of claim 9 further comprises comparing the upper and lower bound addresses and preventing programming of the memory array whenever the lower bound address is greater than the upper bound address irrespective of the logic level of the control bit.

14. The method of claim 9, wherein the upper and lower bound regions are upper and lower bound memory blocks of the memory array having the upper and lower bound addresses and the regions of the memory array having addresses between the upper and lower bound addresses are memory blocks of the memory array having addresses between the upper and lower bound addresses.

15. The method of claim 9 further comprises allowing programming of any regions of the memory array having addresses greater than the upper bound address and/or addresses less than the lower bound address when the control bit of the memory device is at the first logic level.

16. The method of claim 9 further comprises allowing programming of any regions of the memory array having addresses between the upper and lower bound addresses when the control bit of the memory device is at a second logic level.

17. The method of claim 16 further comprises allowing programming of the upper and lower bound regions when the control bit of the memory device is at the second logic level.

18. A method of operating a memory device, comprising:
receiving a write command having a block address of a memory block of a memory array of the memory device;
determining whether the block address is greater than or equal to a lower bound address and less than or equal to an upper bound address;
preventing the memory block from being written to when the block address is greater than or equal to the lower bound address and less than or equal to the upper bound address when a control bit has a first logic level; and
writing to the memory block having the block address when the block address is greater than or equal to the lower bound address and less than or equal to the upper bound address when the control bit has a second logic level.

19. The method of claim 18 further comprises preventing the memory block from being written to when the lower bound address is greater than the upper bound address, irrespective of the level of the control bit.

20. The method of claim 19 further comprises indicating an error when the lower bound address is greater than the upper bound address.

21. The method of claim 18, wherein the lower bound address is equal to the upper bound address.

22. A method of operating a memory device, comprising:
storing a first address in the memory device corresponding to a first memory location of a memory array of the memory device;
storing a second address in the memory device corresponding to a second memory location of the memory array;
receiving a write command having a third address corresponding to a third memory location of the memory array;
storing a control bit in the memory device;
determining whether the third address is greater than or equal to the first address and less than or equal to the second address;
preventing the third memory location from being written to when the third address is greater than or equal to the first address and less than or equal to the second address and the control bit has a first logic level; and
writing to the third memory location when the third address is greater than or equal to the first address and less than or equal to the second address and the control bit has a second logic level.

23. The method of claim 22 further comprises preventing the third memory location from being written to when the first address is greater than the second address, irrespective of the level of the control bit.

24. The method of claim 23 further comprises indicating an error when the first address is greater than the second address.

25. The method of claim 22, wherein the first address is equal to the second address.

26. A memory device comprising:
a memory array; and
control circuitry for controlling operation of the memory device, wherein the control circuitry is adapted to cause the memory device to perform a method of operation comprising:
preventing programming of upper and lower bound regions of the memory array and any regions of the memory array having addresses between addresses of the upper and lower bound regions or preventing programming of any regions of the memory array having addresses greater than the address of the upper bound region and/or addresses less than the address of the lower bound region.

27. The memory device of claim 26 further comprises registers adapted to store the upper and lower bound addresses.

28. The memory device of claim 26, wherein, in the method, programming of the upper and lower bound regions and any regions of the memory array having addresses between addresses of the upper and lower bound regions is prevented when a control bit has a first logic level and programming of any regions of the memory array having addresses greater than the address of the upper bound region and/or addresses less than the address of the lower bound region is prevented when the control bit has a second logic level.

29. The memory device of claim 28 further comprises a control register adapted to store the control bit.

30. The memory device of claim 26, wherein the method further comprises determining whether the address of the upper bound region is greater than or equal to the address of the lower bound region.

31. The memory device of claim 26, wherein the method further comprises preventing programming of the memory array whenever the address of the lower bound region is greater than the address of the upper bound region.

32. The memory device of claim 26, wherein the upper and lower bound regions are upper and lower bound memory blocks of the memory array, the regions of the memory array having addresses between the addresses of the upper and lower bound regions are memory blocks of the memory array having addresses between addresses of the upper and lower bound memory blocks, and the regions of the memory array having addresses greater than the address of the upper bound region and/or addresses less than the address of the lower bound region are memory blocks of the memory array having addresses greater than the address of the upper bound memory block and/or memory blocks of the memory array having addresses less than the address of the lower bound memory block.

33. The memory device of claim 26, wherein the method further comprises allowing programming of any regions of the memory array having addresses greater than the address of the upper bound region and/or addresses less than the address of the lower bound region while preventing programming of the upper and lower bound regions and any regions of the memory array having addresses between addresses of the upper and lower bound regions.

34. The memory device of claim 26, wherein the method further comprises allowing programming of the upper and lower bound regions and any regions of the memory array having addresses between addresses of the upper and lower bound regions while preventing programming of any regions of the memory array having addresses greater than the address of the upper bound region and/or addresses less than the address of the lower bound region.

35. The memory device of claim 26, wherein the memory array is a NAND memory array.

36. A memory device comprising:
a memory array;
a first register adapted to store an upper bound address corresponding to an upper bound region of the memory array;
a second register adapted to store a lower bound address corresponding to a lower bound region of the memory array;
a third register adapted to store a control bit; and
control circuitry for controlling operation of the memory device, wherein the control circuitry is adapted to cause the memory device to perform a method of operation comprising:
preventing programming of any regions of the memory array having addresses between the upper and lower bound addresses when the control bit is at a first logic level.

37. The memory device of claim 36, wherein the method further comprises preventing programming of the upper and lower bound regions when the control bit is at the first logic level.

38. The memory device of claim 37, wherein the lower bound address is equal to the upper bound address.

39. The memory device of claim 36, wherein the method further comprises comparing the upper and lower bound addresses and preventing programming of the memory array whenever the lower bound address is greater than the upper bound address irrespective of the logic level of the control bit.

40. The memory device of claim 36, wherein the method further comprises allowing programming of any regions of the memory array having addresses greater than the address of the upper bound region and/or addresses less than the address of the lower bound region when the control bit is at the first logic level.

41. The memory device of claim 36, wherein the method further comprises allowing programming of any regions of the memory array having addresses between addresses of the upper and lower bound regions when the control bit is at a second logic level.

42. The memory device of claim 41, wherein the method further comprises allowing programming of the upper and lower bound regions when the control bit of the memory device is at the second logic level.

43. A memory device comprising:
a memory array;
a first register adapted to store an upper bound address corresponding to an upper bound region of the memory array;
a second register adapted to store a lower bound address corresponding to a lower bound region of the memory array;
a third register adapted to store a control bit; and
control circuitry for controlling operation of the memory device, wherein the control circuitry is adapted to cause the memory device to perform a method of operation comprising:
preventing programming of the upper and lower bound regions and any regions of the memory array having addresses between the upper and lower bound addresses when the control bit is at a first logic level; and
preventing programming of any regions of the memory array having addresses greater than the upper bound address and/or addresses less than the lower bound address when the control bit is at a second logic level.

44. The memory device of claim 43, wherein the method further comprises comparing the upper and lower bound addresses and preventing programming of the memory array whenever the lower bound address is greater than the upper bound address irrespective of the logic level of the control bit.

45. The memory device of claim 43, wherein the method further comprises allowing programming of any regions of the memory array having addresses greater than the address of the upper bound region and/or addresses less than the address of the lower bound region when the control bit is at the first logic level.

46. The memory device of claim 43, wherein the method further comprises allowing programming of the upper and lower bound regions and any regions of the memory array having addresses between addresses of the upper and lower bound regions when the control bit is at the second logic level.

47. The memory device of claim 43, wherein the lower bound address is equal to the upper bound address.

48. A memory device comprising:
a memory array; and
logic circuitry adapted to compare an incoming address with an upper bound address corresponding to an upper bound region of the memory array and a lower bound address corresponding to a lower bound region of the memory array and to selectively prohibit write access in response to comparing the incoming address with the upper and lower bound addresses.

49. The memory device of claim 48, wherein the logic circuitry is further adapted to compare the lower bound address to the upper bound address.

50. The memory device of claim 48, wherein selectively prohibiting write access in response to comparing the incoming address with the upper and lower bound addresses occurs when a bit received at the memory device is at a predetermined logic level.

51. A memory device comprising:
a memory array;
a first register adapted to store an upper bound address corresponding to an upper bound memory block of the memory array;
a second register adapted to store a lower bound address corresponding to a lower bound memory block of the memory array;
a third register adapted to store a control bit; and
control circuitry for controlling operation of the memory device, wherein the control circuitry is adapted to cause the memory device to perform a method of operation in response to receiving a write command having a block address of a memory block of the memory array, the method comprising:
preventing the memory block from being written to when the block address is between the lower bound address and the upper bound address when the control bit has a first logic level; and
writing to the memory block having the block address when the block address is between the lower bound address and the upper bound address when the control bit has a second logic level.

52. The memory device of claim 51, wherein the method further comprises preventing the memory block from being written to when the lower bound address is greater than the upper bound address, irrespective of the level of the control bit.

53. The memory device of claim 52, wherein the method further comprises indicating an error when the lower bound address is greater than the upper bound address.

54. The memory device of claim 51, wherein the method further comprises preventing the memory block from being written to when the block address is equal to the lower bound address or equal to the upper bound address when the control bit has the first logic level.

55. The memory device of claim 51, wherein the method further comprises writing to the memory block when the block address is equal to the lower bound address or equal to the upper bound address when the control bit has the second logic level.

56. The memory device of claim 55, wherein the lower bound address is equal to the upper bound address.
